(19) United States
(12) Patent Application Publication
(10) Pub. No.: US 2026/0300137 A1
(43) Pub. Date: Oct. 1, 2026

(54) MACHINE LEARNING MODEL AUTOMATED BUG IDENTIFICATION

(71) Applicant: INTUIT INC., Mountain View, CA (US)

(72) Inventors: Wendy Sen ANDERSON, Carlsbas, CA (US); Emilie BELIS, Seattle, WA (US); FJ COLLINS, Hawthorne, NY (US); Kelsey Rae CONOPHY, Gallatin Gateway, MT (US); Moire CORCORAN, San Diego, CA (US); Brett Richard DENNEY, Alpine, UT (US); Diego FELIX, San Jose, CA (US); Hilary HAYES, Renton, WA (US); David A. RICH, Vail, AZ (US); Gregory Joseph VIVIANO, Oro Valley, AZ (US); Xiaobei WU, Los Angeles, CA (US); Katherine Vanessa WURTZELL, San Diego, CA (US)

(21) Appl. No.: 19/092,028

(22) Filed: Mar. 27, 2025

(51) Int. Cl. G06F 11/362; G06F 11/3698; G06N 20/00

(52) U.S. Cl. CPC G06F 11/366; G06F 11/3698; G06N 20/00

(57) ABSTRACT

Aspects of the present disclosure relate to automated bug identification using machine learning models. Embodiments include instructing a machine learning model, via a prompt, to generate an output according to instructions in the prompt. Embodiments include providing the machine learning model, via the prompt, one or more transcripts, wherein each transcript is associated with a set of user communication data. Embodiments include instructing the machine learning model, via the prompt, to parse the one or more transcripts and create a classification for each given transcript of the one or more transcripts based on one or more attributes of the given transcript. Embodiments include instructing the machine learning model, via the prompt, to provide the classification for each given transcript as the output in a structured object format. Embodiments include receiving the output from the machine learning model in response to the prompt and performing an action based on the output.

### INTRODUCTION

Aspects of the present disclosure relate to techniques for automated bug identification using machine learning models. In particular, techniques described herein involve instructing a machine learning model, via a prompt, to parse one or more transcripts, automatically classify each transcript as being bug-related or not bug-related according to certain attributes, and provide the classification as an output in a structured file format.

### BACKGROUND

Every year, millions of people, businesses, and organizations around the world use software applications to assist with countless aspects of life. Because of this, both the amount of software applications and the complexity of software applications have greatly increased. This increase has often led to significant amounts of issues, or bugs, that arise in those software applications. These bugs can cause a number of problems for a user of a software application, including programs slowing or crashing, inoperable features, reduced security, and/or the like. With both business and personal transactions occurring on a global scale, even small and/or temporary bugs can result in significant ramifications. Identifying bugs, especially in a timely manner, is therefore crucial to providing the necessary support and solutions to keep the applications running smoothly. Existing techniques require extensive manual processing in identifying, triaging, and resolving a myriad of bug-related issues. This causes high support costs in both time and resources, as well as causes a diminished user experience.

Thus, there is a need in the art for improved techniques for automatically identifying bugs in software applications.

### BRIEF SUMMARY

Certain embodiments provide a method of automated bug identification using machine learning models. The method generally includes: instructing a machine learning model, via a prompt, to generate an output according to instructions contained in the prompt; providing the machine learning model, via the prompt, one or more transcripts, wherein each transcript of the one or more transcripts is associated with a set of user communication data; instructing the machine learning model, via the prompt, to parse the one or more transcripts and create a classification for each given transcript of the one or more transcripts based on one or more attributes of the given transcript; instructing the machine learning model, via the prompt, to provide the classification for each given transcript of the one or more transcripts as the output in a structured object format; receiving the output from the machine learning model in response to the prompt; and performing an action based on the output.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of workflow related to automated bug identification using machine learning models.

FIG. 2 depicts an additional example of workflow related to automated bug identification using machine learning models.

FIG. 3 is a block diagram illustrating an example related to automated bug identification using machine learning models.

FIG. 4 depicts example operations related to automated bug identification using machine learning models.

FIG. 5 depicts an example of a processing system for automated bug identification using machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated bug identification using machine learning models.

Bugs in software applications may cause significant issues when left undetected and/or unresolved. Often times, those bugs may not be detected before reaching a user of a software application. The bugs may then be reported during conversations between users and support professionals. Current techniques for identifying and tracking bugs from those conversations, however, require manual processing and are error prone, leading to bugs remaining undetected and/or unresolved. To improve automated bug detection, particularly based on customer feedback, techniques described herein employ machine learning models to automatically identify bugs by parsing and classifying transcripts provided via a prompt to a machine learning model and outputting the results in a specified format for further processing (e.g., by a bug processing system to count and store data related to the classification). Such techniques result in an automated process for bug detection that is more efficient, more accurate, and more thorough, improving downstream processing and repairs. For example, a machine learning model, such as a language processing machine learning model, may be instructed, via a prompt, to generate an output according to instructions contained in the prompt. The language processing machine learning model may, for instance, be a large language model capable of processing natural language inputs and generating natural language outputs. The machine learning model may then be provided with one or more transcripts, where each transcript may be associated with a set of user communication data. For example, the user communication data may be gathered in real-time from an ongoing conversation (i.e., between a product user and a support specialist) or may be transcribed and compiled from a conversation after it has been concluded. In some cases, if a particular transcript exceeds a predefined length, the transcript may be divided into smaller, overlapping transcripts for processing by the machine learning model. Such division ensures that lengthy and/or complex transcripts are processed more efficiently and accurately while the overlapping of the smaller transcripts provides the necessary context when transitioning from one to the next.

The machine leaning model may then be instructed via the prompt to parse the one or more transcripts and create a classification for each transcript based on one or more attributes of the given transcript. The classifications may include an indication of whether content of the given transcript is related to a bug, an indication of one or more products referenced in the given transcript, an indication of a severity level associated with the bug (i.e., if one was detected), or a combination thereof. The attributes evaluated in each transcript may include certain keywords or phrases, a product name, an investigation number, and/or the like. In cases where a transcript is divided into smaller transcripts, if one of the smaller transcripts is classified as bug-related, then the entire transcript, from which the smaller transcript was generated, may also be classified as bug-related.

The machine learning model may then be instructed via the prompt to provide the classification for each given transcript as the output in a structured object format, such as JavaScript Object Notation (JSON). The output may then be received from the machine learning model in response to the prompt and an action may be performed based on the output. For example, the output may be provided to a bug processing system, which may store a count of the classification for each given transcript and transmit data associated with the classification for each given transcript to a user interface or to one or more elements of a software application.

Embodiments of the present disclosure provide numerous technical and practical effects and benefits. As noted above, swift and accurate bug detection is imperative in software application maintenance and support. Existing techniques for bug detection, however, require extensive manual processing, including the flagging of potential bug-related conversations, which is time-consuming, prone to error, and not scalable. The result is increased costs both in time and the resources expended not only in initial bug detection, but also when errors in that process need to addressed and corrected (e.g., resources are wasted when a product that does not need to be repaired is erroneously flagged as having a bug as well as when problems continue to exist and even worsen in a product that was not flagged as having a bug and timely fixed). The user also faces a reduced experience due to extended times for repair as well as potential financial or other ramifications from downtime, security risk, and/or the like. The present disclosure solves these technical problems. Techniques described herein ensure accurate and efficient bug detection by automatically identifying and categorizing bugs in transcripts provided to a machine learning model (including from real-time conversations), significantly decreasing the time and resources previously needed for bug detection, while at the same time drastically increasing the scale to which transcripts may be automatically processed. Additionally, dividing lengthy transcripts into smaller, less complex chunks further improves the brevity and accuracy with which the machine learning model processes the transcripts. And, by creating smaller transcripts that contain a certain amount of overlapping content, the necessary context is provided to the model, further minimizing error in the process. These techniques not only save resources during the bug detection, but they also save resources that would otherwise be expended due to delayed detection and/or errors in the detection by allowing for processing of large numbers of transcripts at once and also eliminating the human error that often leads to false positives and false negatives.

### Example Workflows Related to Automated Bug Identification Using Machine Learning Models

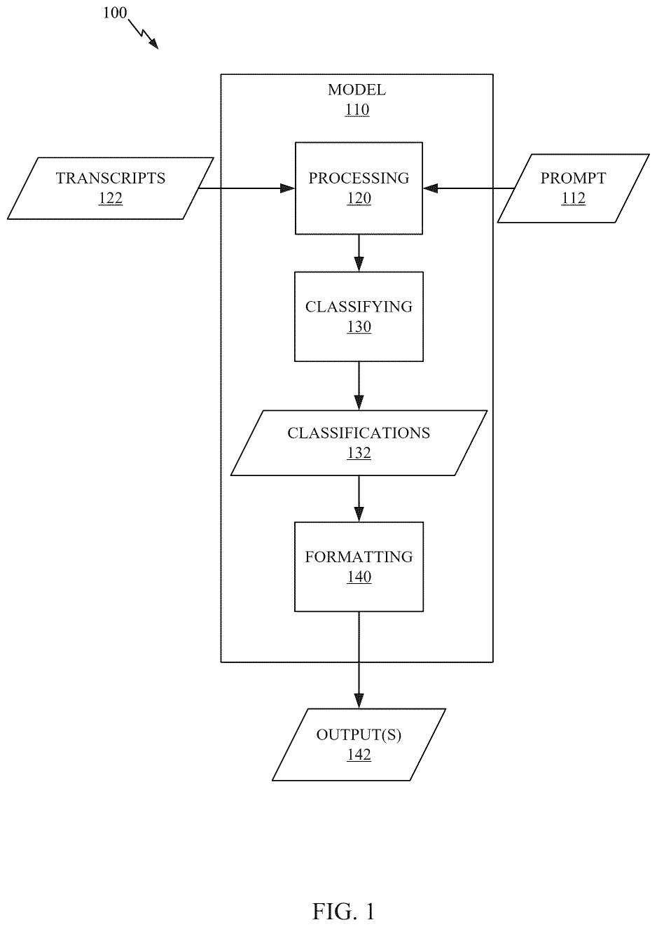

FIG. 1 depicts an example workflow 100 related to automated bug identification using machine learning models. For example, workflow 100 may represent a series of steps associated with processing and classifying transcripts and, in response, providing an output in a particular format.

A model 110 may comprise a machine learning model. In a particular example, model 110 is a language processing machine learning model such as a large language model (LLM). For example, model 110 may have been trained on a large training data set in order to process natural language inputs and generate natural language content in response. In some embodiments, model 110 is a generative pre-trained transformer (GPT) model that has been trained on a large set of training data (e.g., across a plurality of domains), and is capable as a result of such training to perform a wide variety of language-related tasks in response to natural language prompts. In some embodiments, model 110 has been fine-tuned for one or more particular domains, such as for use with a particular software application or for a specific purpose, while in other embodiments model 110 has been trained in a more general fashion and has not been fine-tuned in such a manner. Model 110 may have a large number of tunable parameters, which are iteratively adjusted during a model training process based on training data. In alternative embodiments, model 110 may be another type of machine learning model that is capable of generating content. For example, model 110 may be a generative adversarial network (GAN), an autoencoder model, an autoregressive model, a diffusion model, a Bayesian network, a hidden Markov model, and/or the like.

The model 110 may receive a prompt 112. The prompt 112 may contain natural language, code language, or a combination thereof. The prompt 112 may further include instructions for the model 110 to follow, a description of attributes to analyze in transcripts provided to the model 110, the nature of the output the model 110 is to provide, and/or the format in which to provide the output. The prompt 112 may be processed by model 110 during processing 120. A sample prompt is provided below:
“You are a product software support analyst who determines if a customer is experiencing a bug based on the live transcript of the conversation so far. A bug is when a customer has an expectation of how to complete a task and the software isn't behaving as expected. If the agent provides a workaround solution it is still a bug. If the customer didn't know how to do the task and the expert had to walk them through the steps, that is not a bug. Keywords that generally indicate that the user is experiencing a bug are error, issue, problem, crash, not working, etc. The transcript has what you have said labeled with ‘a’ and what the customer has said labeled with ‘c’. The transcript also includes system messages labeled with ‘s’. The following is the live transcript of the conversation so far: </text>“+contact_utterance+”</text> Respond TRUE if the user is experiencing a bug or FALSE otherwise in <bug_flag>. You can also respond with IDK if you cannot figure it out. Respond using JSON format:

```
{bug_flag:<bug_flag>}.”,
  “llm_configuration”: {
    “model”: “text-davinci-003”,
    “max_tokens”: 250,
    “temperature”: 0.1,
    “top_p”: 1,
    “n”: 1,
    “presence_penalty”: 0.01,
    “frequency_penalty”: 0.1,
  },
```

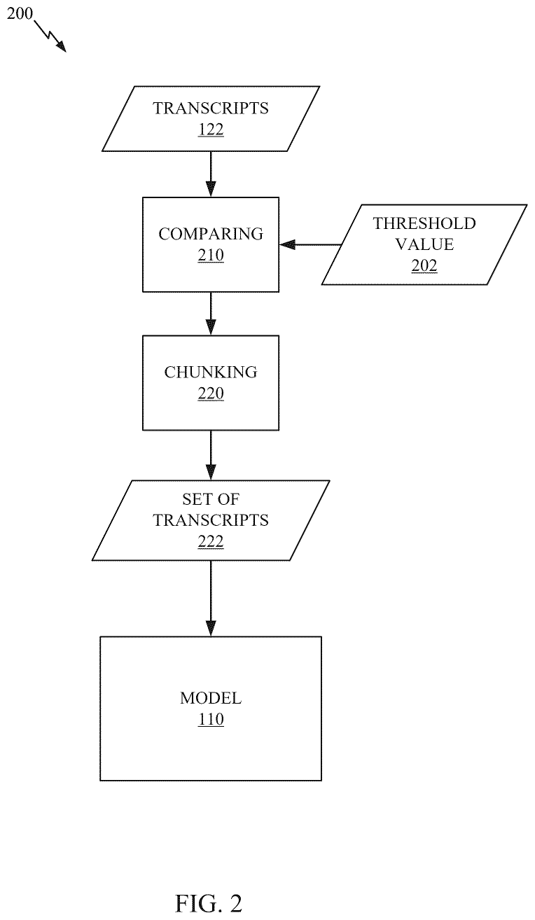

Along with the prompt 112, the model 110 may be provided with one or more transcripts 122. The transcripts 122 may be associated with a set of user communication data. For example, a transcript may have been compiled after a conversation between a user and a support staff individual was concluded. In another example, the transcript may comprise data extracted from an ongoing conversation between the user and support staff. This allows for a conversation to be flagged in real-time by the model, thereby saving time and resources. One or more transcripts of transcripts 122 may undergo processing before being provided to the model, such as being divided into smaller subsets of transcripts, as described in more detail with respect to FIG. 2.

During classifying 130, the model 110 may parse transcripts 122 and create a classification for each transcript of the transcripts 122 based on one or more attributes of the particular transcript. Attributes may correspond to a feature or features of the transcript that are likely to indicate whether the transcript is bug-related. Those attributes may include one or more keywords, one or more phrases, a product name, or an investigation number, among others. For example, if a particular transcript contains a specified combination of “error,” “issue,” and/or “crash,” then the transcript is to be classified as bug-related. In addition to an indication of whether the content of the transcript is related to a bug, the classification for each transcript may comprise an indication of one or more products referenced in the respective transcript, an indication of a severity level associated with the bug, and/or the like. Attributes such as a product name and/or investigation number may be used to determine those elements of the classification.

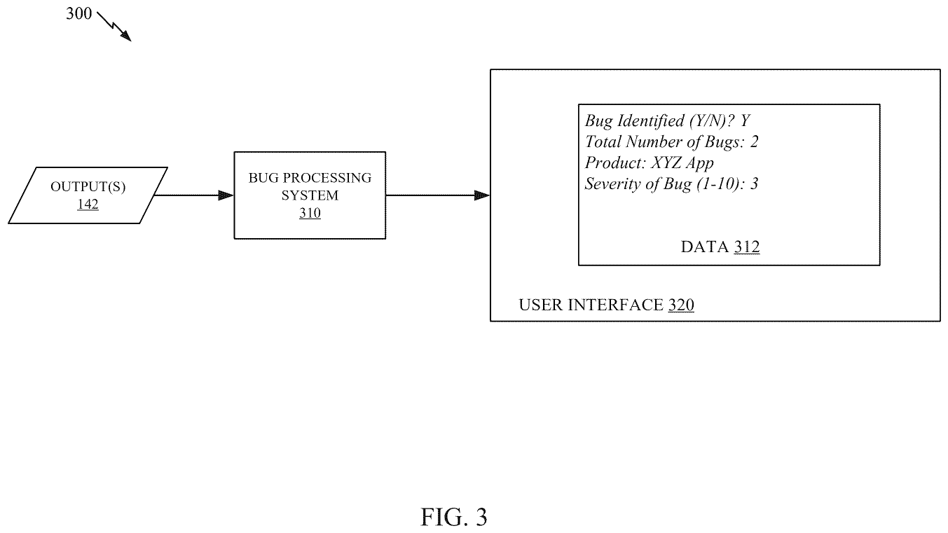

As instructed in the prompt 112, the classifications 132 may then be provided as output(s) 142. During formatting 140, the classifications 132 may be transformed into outputs in the specified format. For instance, the model 110 may be instructed, via the prompt, to generate the output(s) 142 in a structured file format. A structured file format, such as JSON, is a standardized, text-based format used for storing and transmitting data. The output(s) 142 may then be received from the model 110 in response to the prompt 112 and further actions may be performed with the output(s) 142. For example, the output may be provided to a bug processing system, wherein the bug processing system stores a count of the classification for each transcript of transcripts 122 and transmits data associated with each classification of classifications 132 to a user interface or to one or more elements of a software application, as described in more detail below with respect to FIG. 3. In some embodiments, the structured object format of the output corresponds to an expected input format for the bug processing system. Additionally, the accuracy of the model in properly identifying bugs may be measured, such as by using a confusion matrix and/or an F-score. Based on the results, the prompt 112 may be updated with more and/or different attribute descriptors, examples, and/or the like to improve the classifications 132 generated by the model 110.

FIG. 2 depicts an additional example workflow 200 related to automated bug identification using machine learning models. In particular, FIG. 2 depicts a series of steps that may be performed prior to the processing of FIG. 1 in which transcripts are partitioned according to their respective lengths.

If a transcript of transcripts 122 exceeds a certain length, it may receive pre-processing before it is passed to the model 110. For example, each transcript of transcripts 122 may be compared, during comparing 210, to a threshold value 202 (e.g., corresponding to a page length, number of characters, and/or the like). If the length of a transcript is greater than the threshold value 202, it may undergo chunking 220, where the particular transcript is divided into multiple, smaller transcripts. This allows for lengthy and/or complex transcripts to be shortened and simplified, resulting in faster and more accurate processing. The smaller transcripts may also overlap each other (i.e., a specified amount of the content at the end of one transcript may be repeated at the beginning of the next transcript) ensuring that the model has relevant context during the classification stage. A sample set of commands for the chunking is provided below:

```
  def split_transcript(transcript, chunk_size):
    “““
    Split transcript into chunks of length chunk_size with the last chunk
    padded if remaining words are fewer than chunk_size.
    ”””
    transcript_length = len(transcript)
    chunks = [ ]
    start_idx = 0
    while start_idx < transcript_length:
      end_idx = start_idx + chunk_size
      if end_idx < transcript_length:
        # Find the last space within the chunk_size range, to avoid
        splitting words across chunks
        left_word_idx = transcript.rfind(‘ ’, start_idx, end_idx)
        if left_word_idx != start_idx−1:
          end_idx = left_word_idx + 1
      chunk = transcript[start_idx: end_idx].strip( )
      chunks.append(chunk)
      start_idx = end_idx
    return chunks
  chunk_size = 3000
  df_chunks = pd.DataFrame(columns=[“contactid”, “chunk_order”,
  “transcript_chunk”])
  for index, row in df.iterrows( ):
    contactid = row[“contactid”]
    transcript = row[“contact_utterance”]
    transcript_chunks = split_transcript(transcript, chunk_size)
    for i, chunk in enumerate(transcript_chunks):
      df_chunks = df_chunks.append({“contactid”: contactid,
      “chunk_order”: i+1, “transcript_chunk”: chunk},
      ignore_index=True)
print(df_chunks.head( ))
```

The resulting set of transcripts 222 may then be passed to the model 110 for processing as depicted in FIG. 1. If, on the other hand, the length of a transcript does not exceed the threshold value 202, it may be passed directly to the model 110 rather than undergoing chunking 220.

### Example Block Diagram Related to Automated Bug Identification Using Machine Learning Models

FIG. 3 depicts a block diagram 300 illustrating an example related to automated bug identification using machine learning models. For example, block diagram 300 may represent post-processing of the outputs generated by one or more steps described with respect to FIG. 1 and/or FIG. 2 and displayed on a user interface 320 (e.g., associated with a computing application running on a computing device).

Once the output(s) 142 are received from the model 110, they may be provided to a bug processing system 310. The bug processing system 310 may comprise one or more computing devices and/or components configured to receive data in a structured object format (e.g., output(s) 142) and perform one or more tasks based on the data. In one case, the bug processing system 310 may transmit data 312 associated with the classification for each transcript to a user interface 310. For example, the user interface 310 may display whether a bug was identified in a particular transcript, how many bugs were detected (e.g., how many bugs were detected overall across a given batch of transcripts), the product affect by the bug identified in the particular transcript, and/or the severity of the bug (e.g., an assigned score on a predefined scale related to the relative magnitude of the issue, the effort required to correct the issue, and/or the like). The bug processing system 310 may also be configured to store the data 312 for recall at a later time and/or to maintain a continuously updated count of the number of transcripts flagged as bug-related. In some embodiments, the bug processing system 310 may be configured to generate one or more proposed solutions to one or more of the identified bugs. For example, model 110 of FIG. 1 may be instructed via a prompt (e.g., the same prompt that instructs the model to classify a transcript as bug-related or not bug-related, such as prompt 112 of FIG. 1, or a different prompt, such as a prompt provided to the model after output(s) 142 are generated and provided along with output(s) 142 to the model) to generate one or more proposed solutions to the one or more identified bugs, and model 110 may output one or more proposed solutions in response (e.g., as part of output(s) 142 or separately). A proposed solution may comprise a suggested repair workflow, software patch, sample code, and/or the like. Once generated, the proposed solution may be passed, for example, to a support technician, their device, and/or displayed on an associated user interface.

### Example Operations Related to Automated Bug Identification Using Machine Learning Models

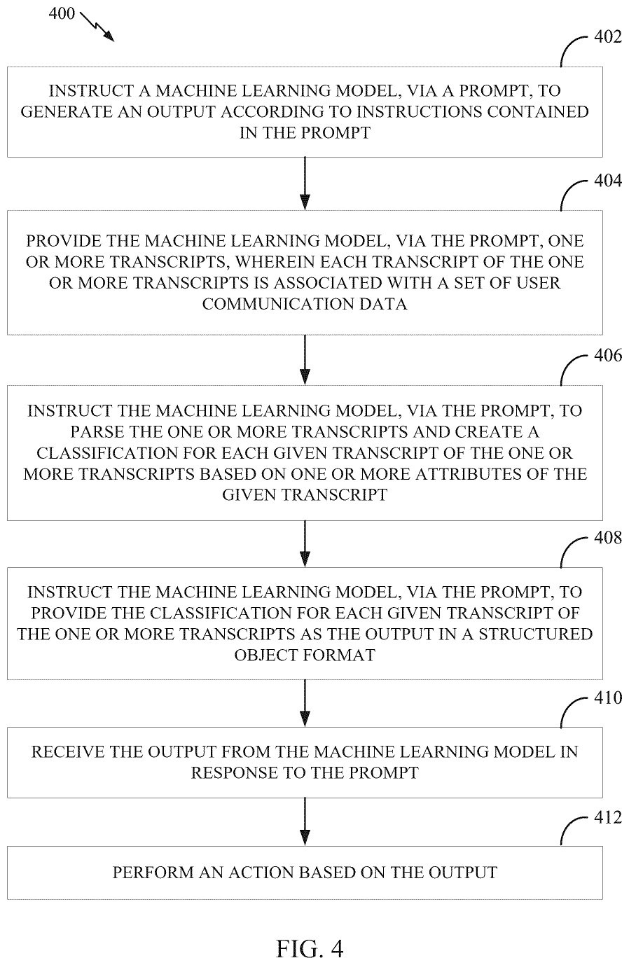

FIG. 4 depicts example operations 400 related to automated bug identification using machine learning models. For example, operations 400 may be performed by one or more of the components described with respect to FIG. 1, FIG. 2, and/or FIG. 3.

Operations 400 begin at step 402 with instructing a machine learning model, via a prompt, to generate an output according to instructions contained in the prompt.

Operations 400 continue at step 404 with providing the machine learning model, via the prompt, one or more transcripts, wherein each transcript of the one or more transcripts is associated with a set of user communication data. According to certain embodiments, the set of user communication data comprises a stream of data gathered in real-time from an ongoing conversation. In some embodiments, the providing the machine learning model, via the prompt, the one or more transcripts comprises, for any particular transcript of the one or more transcripts that exceeds a specified length, dividing the particular transcript into subsets comprising smaller transcripts not exceeding the specified length, wherein the subsets contain overlapping sections of content. Other embodiments provide that a given classification is assigned to the particular transcript of the one or more transcripts that exceeds the specified length based on the given classification being associated with one of the smaller transcripts not exceeding the specified length.

Operations 400 continue at step 406 with instructing the machine learning model, via the prompt, to parse the one or more transcripts and create a classification for each given transcript of the one or more transcripts based on one or more attributes of the given transcript. Some embodiments provide that the classification for each respective transcript of the one or more transcripts comprises one or more of: an indication of whether content of the respective transcript is related to a bug; an indication of one or more products referenced in the respective transcript; or an indication of a severity level associated with the bug. In other embodiments, the one or more attributes comprises one or more of: one or more keywords; one or more phrases; a product name; or an investigation number.

Operations 400 continue at step 408 with instructing the machine learning model, via the prompt, to provide the classification for each given transcript of the one or more transcripts as the output in a structured object format.

Operations 400 continue at step 410 with receiving the output from the machine learning model in response to the prompt.

Operations 400 continue at step 412 with performing an action based on the output. In certain embodiments, the performing of the action based on the output comprises providing the output to a bug processing system, wherein the bug processing system stores a count of the classification for each given transcript of the one or more transcripts and transmits data associated with the classification for each given transcript of the one or more transcripts to a user interface or to one or more elements of a software application.

### Example of a Processing System for Automated Bug Identification Using Machine Learning Models

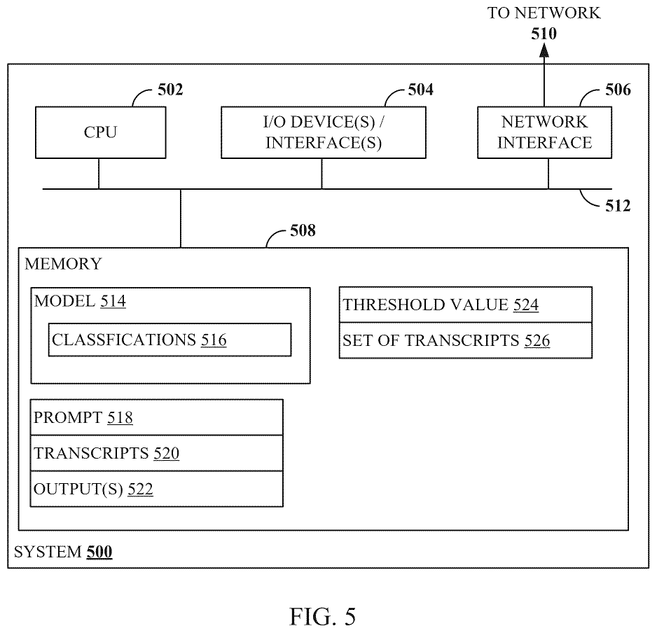

FIG. 5 illustrates an example system 500 with which embodiments of the present disclosure may be implemented. For example, system 500 may be configured to perform operations 400 of FIG. 4 and/or to implement one or more components as in FIG. 1, FIG. 2, or FIG. 3.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 408, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes model 514, classifications 516, prompt 518, transcripts 520, and output(s) 522. Model 514 may be representative of model 110 of FIG. 1 and FIG. 2. Classifications 516 may be representative of classifications 132 of FIG. 1. Prompt 518 may be representative of prompt 112 of FIG. 1. Transcripts 520 may be representative of transcripts 122 of FIG. 1 and FIG. 2. Output(s) 522 may be representative of output(s) 142 of FIG. 1 and FIG. 3.

Memory 508 further comprises threshold value 524 which may correspond to threshold value 202 of FIG. 2. Memory 508 further comprises set of transcripts 526, which may correspond to set of transcripts 222 of FIG. 2. Memory 508 further comprises directions 430, which may correspond to directions 208 of FIG. 2. It is noted that in some embodiments, system 500 may interact with one or more external components, such as via network 510, in order to retrieve data and/or perform operations. Furthermore, techniques described herein may be implemented via more or fewer components than those shown and described with respect to FIG. 5, such as on one or more computing systems.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automated bug identification using machine learning models, comprising:
instructing a machine learning model, via a prompt, to generate an output according to instructions contained in the prompt;
providing the machine learning model, via the prompt, one or more transcripts, wherein each transcript of the one or more transcripts is associated with a set of user communication data;
instructing the machine learning model, via the prompt, to parse the one or more transcripts and create a classification for each given transcript of the one or more transcripts based on one or more attributes of the given transcript;
instructing the machine learning model, via the prompt, to provide the classification for each given transcript of the one or more transcripts as the output in a structured object format;
receiving the output from the machine learning model in response to the prompt; and
performing an action based on the output.

2. The method of claim 1, wherein the providing the machine learning model, via the prompt, the one or more transcripts comprises, for any particular transcript of the one or more transcripts that exceeds a specified length, dividing the particular transcript into subsets comprising smaller transcripts not exceeding the specified length, wherein the subsets contain overlapping sections of content.

3. The method of claim 2, wherein a given classification is assigned to the particular transcript of the one or more transcripts that exceeds the specified length based on the given classification being associated with one of the smaller transcripts not exceeding the specified length.

4. The method of claim 1, wherein the set of user communication data comprises a stream of data gathered in real-time from an ongoing conversation.

5. The method of claim 1, wherein the classification for each respective transcript of the one or more transcripts comprises one or more of:
an indication of whether content of the respective transcript is related to a bug;
an indication of one or more products referenced in the respective transcript; or
an indication of a severity level associated with the bug.

6. The method of claim 1, wherein the one or more attributes comprises one or more of:
one or more keywords;
one or more phrases;
a product name; or
an investigation number.

7. The method of claim 1, wherein the performing of the action based on the output comprises providing the output to a bug processing system, wherein the bug processing system stores a count of the classification for each given transcript of the one or more transcripts and transmits data associated with the classification for each given transcript of the one or more transcripts to a user interface or to one or more elements of a software application.

8. A system for automated bug identification using machine learning models, comprising:
one or more processors; and
a memory comprising instructions that, when executed by the one or more processors, cause the system to:
instruct a machine learning model, via a prompt, to generate an output according to instructions contained in the prompt;
provide the machine learning model, via the prompt, one or more transcripts, wherein each transcript of the one or more transcripts is associated with a set of user communication data;
instruct the machine learning model, via the prompt, to parse the one or more transcripts and create a classification for each given transcript of the one or more transcripts based on one or more attributes of the given transcript;
instruct the machine learning model, via the prompt, to provide the classification for each given transcript of the one or more transcripts as the output in a structured object format;
receive the output from the machine learning model in response to the prompt; and
perform an action based on the output.

9. The system of claim 8, wherein the providing the machine learning model, via the prompt, the one or more transcripts comprises, for any particular transcript of the one or more transcripts that exceeds a specified length, dividing the particular transcript into subsets comprising smaller transcripts not exceeding the specified length, wherein the subsets contain overlapping sections of content.

10. The system of claim 9, wherein a given classification is assigned to the particular transcript of the one or more transcripts that exceeds the specified length based on the given classification being associated with one of the smaller transcripts not exceeding the specified length.

11. The system of claim 8, wherein the set of user communication data comprises a stream of data gathered in real-time from an ongoing conversation.

12. The system of claim 8, wherein the classification for each respective transcript of the one or more transcripts comprises one or more of:
an indication of whether content of the respective transcript is related to a bug;
an indication of one or more products referenced in the respective transcript; or
an indication of a severity level associated with the bug.

13. The system of claim 8, wherein the one or more attributes comprises one or more of:
one or more keywords;
one or more phrases;
a product name; or
an investigation number.

14. The system of claim 8, wherein the performing of the action based on the output comprises providing the output to a bug processing system, wherein the bug processing system stores a count of the classification for each given transcript of the one or more transcripts and transmits data associated with the classification for each given transcript of the one or more transcripts to a user interface or to one or more elements of a software application.

15. A non-transitory computer readable medium comprising instructions that, when executed by one or more processors of a computing system, cause the computing system to:
instruct a machine learning model, via a prompt, to generate an output according to instructions contained in the prompt;
provide the machine learning model, via the prompt, one or more transcripts, wherein each transcript of the one or more transcripts is associated with a set of user communication data;
instruct the machine learning model, via the prompt, to parse the one or more transcripts and create a classification for each given transcript of the one or more transcripts based on one or more attributes of the given transcript;
instruct the machine learning model, via the prompt, to provide the classification for each given transcript of the one or more transcripts as the output in a structured object format;
receive the output from the machine learning model in response to the prompt; and
perform an action based on the output.

16. The non-transitory computer readable medium of claim 15, wherein the providing the machine learning model, via the prompt, the one or more transcripts comprises, for any particular transcript of the one or more transcripts that exceeds a specified length, dividing the particular transcript into subsets comprising smaller transcripts not exceeding the specified length, wherein the subsets contain overlapping sections of content.

17. The non-transitory computer readable medium of claim 16, wherein a given classification is assigned to the particular transcript of the one or more transcripts that exceeds the specified length based on the given classification being associated with one of the smaller transcripts not exceeding the specified length.

18. The non-transitory computer readable medium of claim 15, wherein the classification for each respective transcript of the one or more transcripts comprises one or more of:
an indication of whether content of the respective transcript is related to a bug;
an indication of one or more products referenced in the respective transcript; or
an indication of a severity level associated with the bug.

19. The non-transitory computer readable medium of claim 15, wherein the one or more attributes comprises one or more of:
one or more keywords;
one or more phrases;
a product name; or
an investigation number.

20. The non-transitory computer readable medium of claim 15, wherein the performing of the action based on the output comprises providing the output to a bug processing system, wherein the bug processing system stores a count of the classification for each given transcript of the one or more transcripts and transmits data associated with the classification for each given transcript of the one or more transcripts to a user interface or to one or more elements of a software application.
